(19) United States
(12) Patent Application Publication
(10) Pub. No.: US 2017/0318833 A1
(43) Pub. Date: Nov. 9, 2017

(54) AERATED CONFECTION WITH INTERFACIALLY STABILISED AIR CELLS

(71) Applicant: NESTEC S.A., Vevey (CH)

(72) Inventors: Corina Curschellas, New York, NY (US); Zeynel Deniz Gunes, Lausanne (CH); Cecile Gehin-Delval, Les Hopitaux Neufs (FR); Helene Deyber, Jougne (FR); Hans Jorg Werner Limbach, Epalinges (CH)

(21) Appl. No.: 15/329,469

(22) PCT Filed: Jul. 29, 2015
(86) PCT No.: PCT/EP2015/067388

§ 371 Date: Jan. 26, 2017

(30) Foreign Application Priority Data
Jul. 31, 2014 (EP) 14179233.3

(51) Int. Cl. A23G 9/46; A23G 3/52; A23G 9/32

(52) U.S. Cl. CPC A23G 9/46; A23G 9/327; A23G 3/52; A23V 2300/04; A23V 2200/02; A23V 2300/20; A23V 2300/31; A23V 2250/186

(57) ABSTRACT

An aerated confection is disclosed. The aerated confection comprising as an emulsifier polyglycerol ester (PGE) which is present at an air-water interface of air cells in the aerated confection. A method for the manufacture of the aerated confection is also disclosed.

### FIELD OF INVENTION

The present invention relates to aerated confections. In particular the present invention relates to a stabilisation of air cells in the aerated confections.

### BACKGROUND OF INVENTION

Aerated confection, particularly ice-cream, is a complex system comprising a foamed structure or foam, which means that a significant fraction of air is enclosed in bubbles. Aerated ice-cream comprises air cells that are dispersed in a partially frozen continuous phase.

Generally in a first step for the manufacture of the aerated ice-cream, ingredients (such as cream, milk, milk solids, sugars, water, stabilisers and emulsifiers) are combined into a mix. The sugars that are also added to the mix during manufacture are dissolved in a water phase. The mix is then pasteurised and homogenised. The homogenisation creates a milk-fat emulsion of droplets of fat dispersed in the water phase. The milk-fat emulsion is then cooled so that the milk-fat partially solidifies to provide an ice-cream mix in which solid fat crystals are cemented together by liquid fat.

The milk-fat emulsion is then aerated (for e.g. by whipping) and frozen. Aeration and freezing causes the milk-fat emulsion to undergo a process called partial coalescence, in which the fat droplets form clusters of fat that surround and stabilise the air cells that are formed by aeration. The emulsifiers aid developing the fat droplets forming clusters of fat that surround and stabilise the air cells. Aeration and freezing leads to two discrete structural changes in the milk-fat emulsion, namely a formation of ice crystals and a formation of the air cells that are dispersed in the partially frozen continuous phase.

A document by Curschellas et al. is titled “Interfacial aspects of the stability of polyglycerol ester covered bubbles against coalescence” (Soft Matter, Issue 46, Vol. 8, pp. 11620-11631, 2012). This document by Curschellas et al. discloses that many liquid foams are not stable which could be attributed to coalescence which may act as the main destabilization system. The document by Curschellas et al. discloses the coalescence effects of bubbles covered by a polyglycerol ester (PGE) surfactant.

A further document by Curschellas et al. is titled “Foams stabilized by multilamellar polyglycerol ester self-assemblies” (Langmuir, 2013, Vol. 29 (1), pp. 38-49). This document by Curschellas et al. discloses the self-assemblies of the nonionic surfactant polyglycerol ester (PGE) in bulk solutions, at the interface and within foams, using a combined approach of small-angle neutron scattering, neutron reflectivity, and electron microscopy. This document by Curschellas et al. discloses an adsorption of the multilamellar structures present in the bulk solutions leading to a multilayered film at an air-water interface.

European patent application publication No. EP 1889544A discloses aqueous foams and food products containing the aqueous foams which have an improved and modular product texture. A process of producing the foamed food products is disclosed. The process of producing the foamed food products includes in a first step, a provision of a primary aqueous foam and in a second step, in which the primary aqueous foam is added to a food product to be further foamed.

International patent application publication No. WO 2008/009618A discloses a low calorie, low fat food product of a foodstuff and a stable foam. The stable foam has a liquid matrix, gas bubbles and a structuring agent that forms a lamellar or vesicle cage structure without generating a gel, which would impart a rubbery texture. The lamellar or vesicular cage structure entraps a substantial portion of the bubbles and liquid matrix therein in a sufficiently compact structure, that prevents drainage of the liquid matrix and coalescence and creaming of the bubbles which in turn maintains a stability of the foam even when the foam is subjected to heat shock.

US patent publication No. US 3,936-391 discloses a low calorie food product which may be described as gas-in-water emulsion or foam. A structure of the emulsion or foam is dependent upon specific emulsifying agents and stabilisers.

International patent application publication No. WO 2012/168722 A1 discloses a use of a mono- or di-ester of glycerol and moringa oil to prepare a food or feed. The food products can be ice cream. The document discloses that in emulsions, an interfacial tension was reduced by PGPR (glycerol ester) and the moringa oil.

The air cells are an important component in the aerated ice-cream. The air cells affect the physical, sensory and the storage properties of the aerated ice-cream. For example during variations in temperature (i.e. heat-shock) that the aerated ice-cream is often exposed too, the air cells are prone to for example, shrinkage, rupturing and expansion which often leads to a coarsening of the air cells in the aerated ice-cream. This poses problems because the aerated ice-cream becomes gritty and crunchier as larger ice crystals grow at the expense of smaller ice crystals, creating a coarser texture of the aerated ice-cream.

It is desirable not to compromise the physical, sensory and storage properties as well as the creaminess, softness and smoothness and a resistance to shrinkage and melting of aerated confection.

There is a need to provide an aerated confection and methods for the manufacture thereof that overcomes the aforementioned drawbacks.

### SUMMARY OF INVENTION

In a first aspect the present disclosure relates to an aerated confection comprising as an emulsifier at least one polyglycerol ester (PGE), wherein the PGE is present at the gas-water interface of the air bubbles comprised in the aerated dessert product. In a further aspect the present disclosure relates to a method for the manufacture of an aerated confection. The method comprises the steps of:
(a) mixing water and an emulsifier polyglycerol ester (PGE) to obtain a PGE solution,
(b) aerating the PGE solution, and
(c) mixing the aerated PGE solution with a confection pre-mix to produce the aerated confection.

In a further aspect the present disclosure relates to an aerated confection obtainable by the method.

In a further aspect the present disclosure relates to a use of an emulsifier polyglycerol ester (PGE) for increasing a heat shock stability of an aerated confection or frozen aerated confection and/or reducing the growth of air cells and/or ice crystal growth in the aerated confection.

### BRIEF DESCRIPTION OF FIGURES

FIG. 1 shows X-ray tomography analysis of an aerated ice-cream product after heat shock wherein no emulsifier polyglycerol ester (PGE) is present at an air-water interface of air cells in the aerated ice-cream product.

FIG. 2 shows X-ray tomography analysis of an aerated ice-cream product after heat shock wherein an emulsifier polyglycerol ester (PGE) is present at an air-water interface of air cells in the aerated ice-cream product.

FIG. 3 shows the scheme defining the large diameter b and the small diameter a for a typical projection of a bubble shape.

FIG. 4 is showing the shape relaxation of bubbles in a melted PGE-based ice-cream.

FIG. 5 is showing the shape relaxation of bubbles in a melted reference ice-cream.

### DETAILED DESCRIPTION

For a complete understanding of the present invention and the advantages thereof, reference is made to the following detailed description.

It should be appreciated that the various aspects and embodiments of the detailed description as disclosed herein are illustrative of the specific ways to make and use the invention and do not limit the scope of invention when taken into consideration with the claims and the detailed description. It will also be appreciated that features from different aspects and embodiments of the invention may be combined with features from different aspects and embodiments of the invention.

By the term confection it is meant a dessert product usually made from water or a dairy product (such as milk and cream), which can be combined with other ingredients such as fruits and flavours.

By the term ice-cream product it is meant a dessert product usually made from dairy products (such as milk and cream), which can be combined with other ingredients such as fruits and flavours. By the term “aerated” it is meant that the confection comprises air cells that have been dispersed in a partially frozen continuous phase. The aerated ice-cream product is intended to include desert products such as ice-creams, custard, yogurt, sorbet, mousse and gelato and encompasses so called dairy desserts. The aerated confection can be frozen. The confection can be an ice cream product. The frozen confection can be a water ice or an ice cream product.

In a first aspect the present disclosure relates to an aerated confection. In a preferred embodiment, the confection can be an ice-cream product. The frozen confection can be a water ice or an ice cream product.

The confection comprises between 0.05 to 1.5 wt % PGE, preferably between 0.1 to 1.0 wt % PGE, or most preferably 0.2 to 0.4 wt % PGE.

The amount of PGE can be selected to efficiently reduce at least one of air cell growth, ice crystal growth and/or improve heat shock resistance.

The emulsifier polyglycerol ester (PGE) can be any one of PGE 55 or PGE 20 or any combination thereof. A further preferred PGE is Santone 8-1-0 or any combination thereof with the above described PGEs. Most preferably the emulsifier is PGE 55. PGE 55 is obtainable from Danisco, Braband, Denmark.

The aerated confection has an overrun of between 5-150%, preferably 50-150% and more preferably an overrun of between 80-120%. The overrun is a measure of the amount of air that has been aerated into the ice cream mixture and is readily measured by the skilled artisan. Air is an important component of the aerated confection and the air affects the physical and sensory properties as well as the storage stability of the aerated confection. If a low amount of air has been aerated into the ice cream mixture, the resulting aerated confection is dense, heavy and more cold eating. If a higher amount of air has been aerated into the ice cream mixture, the resulting aerated confection is lighter, creamier and more warm eating.

In a further aspect the present invention relates to a method for the manufacture of the aerated confection. The method comprises the steps of:
(a) mixing water and an emulsifier polyglycerol ester (PGE) to obtain a PGE solution,
(b) aerating the PGE solution, and
(c) mixing the aerated PGE solution with a confection pre-mix to produce the aerated confection.

The PGE solution comprises between 0.1 wt % to 3 wt % of the emulsifier polyglycerol ester (PGE), preferably 0.5 to 1.5 wt % PGE, more preferably 0.8 to 1.2 wt %, and most preferably 1 wt % PGE.

The ratio of the PGE solution to the confection premix in step (c) can be between 10:90 and 40:60, or it can be preferably between 20:80 and 35:65, or it can more preferably be between 25:75 and 34:66, or can even more preferably be 33.3:66.7, or most preferably about 1:2. The values indicated in the ratios add up to the final total amount.

The final confection comprises the PGE solution and the confection premix. The PGE solution comprises PGE. The confection pre-mix comprises all remaining ingredients that should be contained in the final confection. In particular the confection pre-mix may comprise an ingredient selected from the list consisting of water, one or more flavour compounds, carbohydrates, fat, oil, protein, milk protein, emulsifier(s), stabilizer(s), and combinations thereof.

An ice cream premix may comprise a compound selected from the list consisting of water, carbohydrate (e.g. selected from the group consisting of glucose syrup, sucrose, dextrose, lactose), protein (e.g. whey protein), fat (e.g. coconut fat), emulsifier(s), stabilizer(s), or a combination thereof.

As previously noted the emulsifier polyglycerol ester (PGE) is at least one of PGE 55, PGE 20 and Santone 8-1-0 or any combination thereof.

The PGE solution can be manufactured as described in Duerr-Auster, N. et al. Langmuir, 2007, 23, 12827-12834. The PGE solution is manufactured by weighing the appropriate amount of the emulsifier polyglycerol ester (PGE) and if used NaCl (purity≧99%, Merck, Germany) and CaCl₂ (Calcium chloride dihydrate, purity≧99%, Sigma-Aldrich, Switzerland) and mixing them with Milli-Q water (18.2 MΩ·cm). The PGE solution is then heated to 80° C. in a water bath and maintained at this temperature for approximately 10 minutes. The PGE solution is then cooled in an ice-water bath.

The PGE solution can now be used for up to 40 hours. Preferably, the PEG solution can be used for 12 to 40 hours. After a time of 40 hours the PGE can start to aggregate and sediment (it is then not a solution/stable dispersion anymore) and cannot be foamed anymore.

The resultant PGE solution is then aerated. Aerating the PGE solution can be achieved by using various foaming devices. The foaming device includes, but is not limited to a Mondo-Mix, a kitchen machine like “Hobart” or a membrane foaming device. The PGE solution is aerated to have an overrun of between 20%-400%, preferably 100 to 400%, more preferably 250 to 350% and most preferably an overrun of 300%. The overrun is a measure of the amount of air that has been aerated into the PGE solution and is readily measured by the skilled artisan.

In the aerated PGE solution, it was surprisingly found that the emulsifier polyglycerol ester (PGE) adsorbs irreversibly to air cells that are dispersed in the PGE solution, leading to interfacially stabilised air cells in the aerated PGE solution.

The mixing of the aerated PGE solution with the ice-cream pre-mix is performed by using a mixing apparatus known in the art, such as a surface scrape heat exchanger and a static mixer. The mixing of the aerated PGE solution with the ice-cream pre-mix further aerates the resultant mixture.

The mixing of the aerated PGE solution with the ice-cream pre-mix is performed on a weight basis one part of aerated PGE solution mixed with two parts ice-cream pre-mix.

The mixing occurs at a temperature of between −2° C. to 20° C. and more preferably at a temperature of between 0° C. to 6° C., even more preferably at a temperature 4° C. to 6° C.

Usually the mixing is performed at around 4° C. as this is the typical temperature of the ice cream mix before the freezing step (This has mainly hygienic reasons). The lower limit of −2° C. marks the freezing points of the liquid parts. The upper limit of 20° C. is also motivated by hygienic reasons but also large fluctuations in temperature would destabilize the foam (coarsening and loss of overrun).

The mixing occurs at a pressure of between 1 to 2 bar and more preferably at a pressure of 1.5 bar.

The mixing needs to be performed at a relatively low pressure, because otherwise the bubbles would shrink and re-expand during the mixing, which would lead to a coarsening and a loss of overrun.

The mixing can be performed with a static mixer or with a dynamic mixer before the freezing step.

The mixing of the aerated PGE solution with the ice-cream pre-mix is used to produce the aerated confection with an overrun of between 20-150%, preferably 50-150% and most preferably an overrun of between 80-120%.

Following the mixing of the aerated PGE solution with the ice-cream pre-mix, the resultant aerated confection can be frozen to harden the aerated confection at temperature of between −35 to −55° C., and more preferably at temperature of between −35 to −45°.

In a further aspect the present disclosure relates a use of emulsifier polyglycerol ester (PGE) for increasing a heat shock stability of an aerated confection or frozen aerated confection and/or reducing the growth of air cells and/or ice crystal growth in the aerated confection.

### EXAMPLE 1

### Reference Aerated Confection

A reference aerated confection was manufactured according to the composition as shown in table 1. The emulsifier used was PGE 55. In this case the confection was an ice-cream.

TABLE 1

| | Mass | Total | |
|---|---|---|---|
| | proportion | Solids | Water |
| Ingredient | [wt. %] | [wt. %] | [wt. %] |
| Demineralised Water | 61.140 | 0.000 | 61.140 |
| Glucose Syrup | 9.500 | 9.120 | 0.380 |
| Sugar | 9.000 | 9.000 | 0.000 |
| Whey Protein (15% Protein) | 8.900 | 8.589 | 0.312 |
| Coconut Fat | 7.300 | 7.300 | 0.000 |
| Skimmed Milk Powder | 2.200 | 2.112 | 0.088 |
| Dextrose Monohydrate | 1.500 | 1.365 | 0.135 |
| Emulsifier(s) | 0.280 | 0.277 | 0.003 |
| Stabiliser(s) | 0.180 | 0.165 | 0.016 |
| Total input ingredients [wt. %] | 100.000 | 37.928 | 62.072 |

The dry ingredients are mixed in pre-heated (65° C.) demineralised water in the following order:
1. Protein ingredients (whey protein and the skimmed milk powder).
2. Dextrose monohydrate, emulsifiers and stabilisers.
3. Sugar ingredients (glucose syrup and the sugar).
4. Fat.

The protein ingredients are mixed first as they are the most difficult to dissolve and hydrate.

A premix of the dextrose monohydrate, emulsifier and stabiliser is formed in order to prevent lump formation and to ensure a homogenous distribution of the dextrose monohydrate, emulsifier and stabiliser.

The pH was monitored and adjusted to a pH of 7 (by the addition of HCl or NaOH). However, the pH of the ice cream premix is not relevant for the invention.

The resultant mixture is then homogenised preferably using a high pressure homogeniser. A pressure setting during the homogenisation is 200 bars and 50 bars for a first and a second homogenisation stage respectively.

Following homogenisation the mixture is pasteurised by heating to a temperature of 86° C. and this temperature is maintained for 30 seconds, the mixture is then cooled to 4° C. The pasteurisation and cooling is preferably performed using plate heat exchangers.

The mixture is stored for between 8 to 12 hours at a temperature of approximately 4° C. without agitation, more preferably the mixture is stored for between 8 to 10 hours at a temperature of approximately 4° C. without agitation. The storage of the mixture achieves a full hydration of the mixture and aids partial crystallisation of the fat droplets.

The resultant mix is then aerated and chilled. Mixing occurs at a temperature of between 0 to −10° C. and more preferably at a temperature of −5° C. The mixing occurs at a pressure of between 1 to 2 bar and more preferably at a pressure of 1.5 bar. The mixing occurs at a mixing rate of between 500 to 750 rpm, more preferably at a mixing rate of between 550 to 700 rpm and more preferably at a mixing rate of 600 to 650 rpm.

The mixing provides the aerated ice-cream product with an overrun of approximately 100%.

The aerated ice-cream product is then filled into containers and stored at a temperature of −40° C. for one hour so that the aerated ice-cream product is hardened.

The aerated ice-cream product is then transferred to a temperature of −50° C. for storage and analysis.

The aerated ice-cream product according to example 1 therefore has no emulsifier polyglycerol ester (PGE) present at an air-water interface of air cells in the aerated ice-cream product.

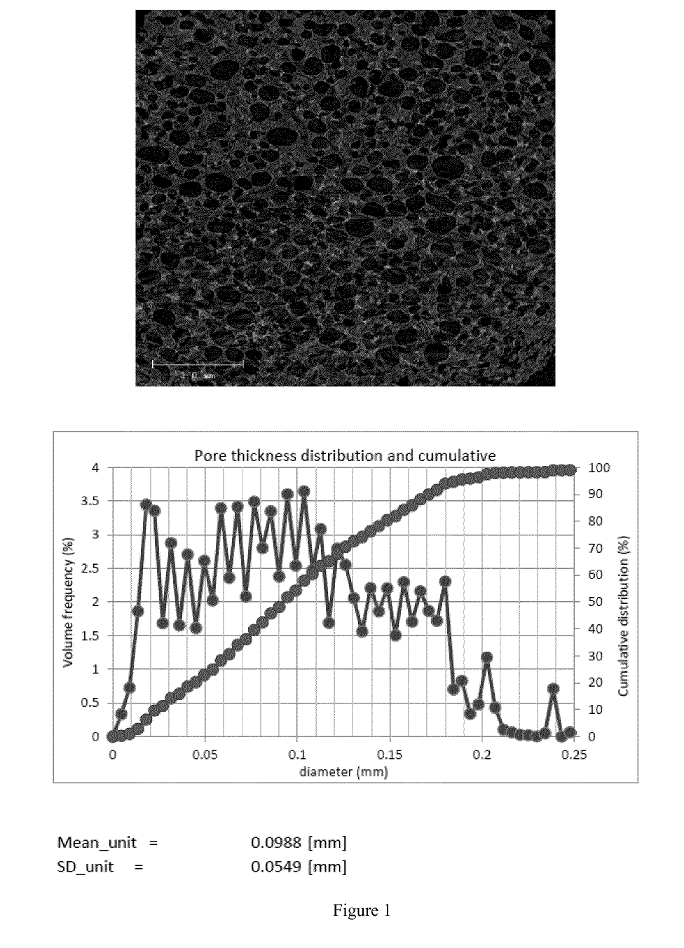

FIG. 1 shows an X-ray tomography analysis of the aerated ice-cream product according to example 1 after heat shock.

### EXAMPLE 2

### Aerated Confection According to Present Invention

An aerated confection, an ice cream product, according to the present invention was manufactured according to the ice-cream pre-mix composition as shown in table 2. The emulsifier used was PGE 55 (Danisco, Braband, Denmark).

TABLE 2

| | Relative | | Mass |
|---|---|---|---|
| Ingredient | quantities | wt. % | [Kg] |
| Demineralised Water* | 30.57 | 45.38 | 22.688 |
| Glucose Syrup | 11.00 | 16.33 | 8.164 |
| Sugar | 9.000 | 13.36 | 6.68 |
| Whey Protein (15% Protein) | 0.00 | 0.00 | 0.00 |
| Coconut Fat | 7.300 | 10.84 | 5.418 |
| Skimmed Milk Powder | 2.200 | 3.27 | 1.633 |
| Dextrose Monohydrate | 1.500 | 2.23 | 1.113 |
| Emulsifier(s) | 0.280 | 0.42 | 0.208 |
| Stabilisers(s) | 0.180 | 0.26 | 0.007 |
| Lactose | 5.34 | 7.93 | 3.963 |
| Total quantities | 67.37 | 100.00 | 50.00 |

*it is to be noted that in the aerated ice-cream product according to the present invention, half the water is replaced by the aerated PGE solution, i.e. 30.57 kg of aerated PGE solution is also used.

The PGE solution was manufactured as described in Duerr-Auster, N. et al. Langmuir, 2007, 23, 12827-12834. The PGE solution is manufactured by weighing the appropriate amount of the emulsifier polyglycerol ester (PGE) and if used NaCl (purity≧99%, Merck, Germany) and CaCl₂ (Calcium chloride dihydrate, purity≧99%, Sigma-Aldrich, Switzerland) and mixing them with Milli-Q water (18.2 MΩ·cm). The PGE solution is then heated to 80° C. in a water bath and maintained at this temperature for approximately 10 minutes. The PGE solution is then cooled in an ice-water bath. The PGE solution is then matured for between 12 to 40 hours.

The resultant PGE solution was aerated to have an overrun of 300%.

In the aerated PGE solution, it was surprisingly found that the emulsifier polyglycerol ester (PGE) adsorbs irreversibly to air cells that are dispersed in the PGE solution, leading to interfacially stabilised air cells in the aerated PGE solution.

The dry ingredients (as noted in table 2) are mixed in pre-heated (65° C.) demineralised water in the following order:
1. Protein ingredients (whey protein and the skimmed milk powder).
2. Dextrose monohydrate, emulsifiers and stabilisers.
3. Sugar ingredients (glucose syrup and the sugar).
4. Fat.

The protein ingredients are mixed first as they are the most difficult to dissolve and hydrate.

A premix of the dextrose monohydrate, emulsifier and stabiliser is formed in order to prevent lump formation and to ensure a homogenous distribution of the dextrose monohydrate, emulsifier and stabiliser.

The aerated PGE solution is then mixed with the aforementioned ice-cream pre-mix on a weight basis one part of aerated PGE solution with two parts ice-cream pre-mix.

It is important to have sufficient time for the hydration of the protein and hydrocolloid ingredients, therefore the mixture is maintained for at least 1 hour and more preferably for at least 2 hours at 65° C. with constant gentle stirring.

The pH was monitored and adjusted to a pH of 7 (by the addition of HCl or NaOH). However, the pH of the ice cream premix is not relevant for the invention.

The resultant mixture is then homogenised preferably using a high pressure homogeniser. A pressure setting during the homogenisation is 200 bars and 50 bars for a first and a second homogenisation stage respectively.

Following homogenisation the mixture is pasteurised by heating to a temperature of 86° C. and this temperature is maintained for 30 seconds, the mixture is then cooled to 4° C. The pasteurisation and cooling is preferably performed using plate heat exchangers.

The mixture is stored for between 8 to 12 hours at a temperature of approximately 4° C. without agitation, more preferably the mixture is stored for between 8 to 10 hours at a temperature of approximately 4° C. without agitation. The storage of the mixture achieves a full hydration of the mixture and aids partial crystallisation of the fat droplets.

The resultant mix is then aerated and chilled. Mixing occurs at a temperature of between 0 to −10° C. and more preferably at a temperature of −5° C. The mixing occurs at a pressure of between 1 to 2 bar and more preferably at a pressure of 1.5 bar. The mixing occurs at a mixing rate of between 500 to 750 rpm, more preferably at a mixing rate of between 550 to 700 rpm and more preferably at a mixing rate of 600 to 650 rpm.

The mixing provides the aerated ice-cream product with an overrun of approximately 100%.

The aerated ice-cream product is then filled into containers and stored at a temperature of −40° C. for one hour so that the aerated ice-cream product is hardened.

The aerated ice-cream product is then transferred to a temperature of −50° C. for storage and analysis.

In the aerated PGE solution, the emulsifier polyglycerol ester (PGE) adsorbs irreversibly to air cells that are dispersed in the PGE solution, leading to interfacially stabilised air cells in the aerated PGE solution, this phenomena was surprisingly carried over to the aerated ice-cream product according to example 2 in which the emulsifier polyglycerol ester (PGE) is present at an air-water interface of air cells in the aerated ice-cream product.

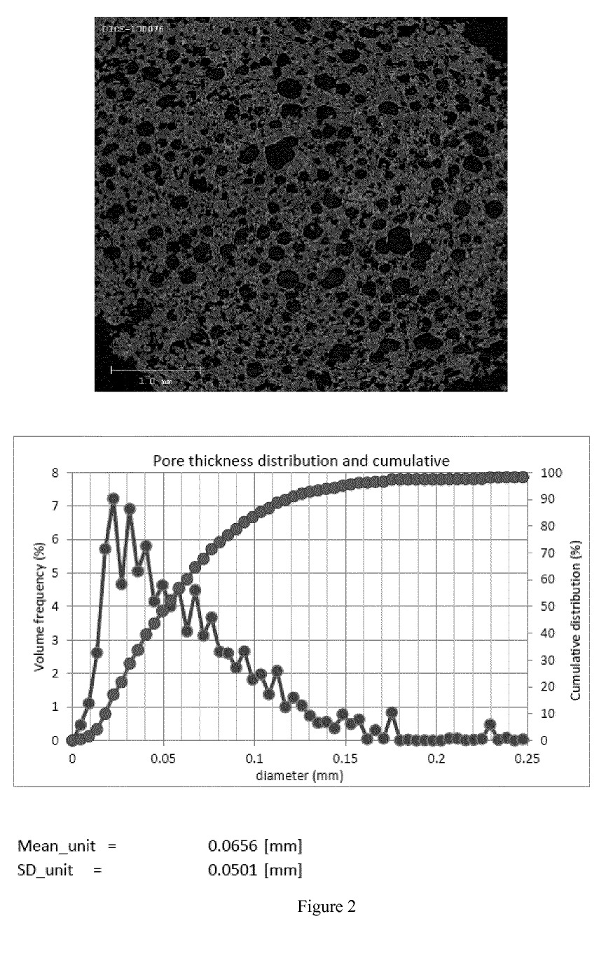

FIG. 2 shows a X-ray tomography analysis of the aerated ice-cream product according to example 2 after heat shock.

The heat shock protocol cycles the temperature between T=−20° C. and T=−5° C. for 16 times over a total period of 160 hours.

From FIGS. 1 and 2 it is shown that, the air cells of the reference aerated ice-cream product (according to Example 1) are approximately 1.5 times larger than the interfacially stabilised air cells (according to Example 2) after a heat shock treatment because the emulsifier polyglycerol ester (PGE) is present at an air-water interface of air cells in the aerated ice-cream product.

In FIG. 1 a mean air cell size after heat shock is 98.9 μm. In FIG. 2 a mean air cell size after heat shock is 65.6 μm. The scale bar in FIGS. 1 and 2 is 1 mm.

For the pore thickness distribution (the graph consisting of a jagged line linking the dots, the graph starting in the lower left corner of the figure and ending in the lower right corner of the figure) an algorithm based on the distance transformation was applied (As described in Pinzer et al., Soft Matter, 2012, Volume 8, Issue 17, Pages 4584-4594 and references therein). The cumulative distribution (the graph consisting of consecutive dots, the graph starting in the lower left corner of the figure and ending in the upper right corner of the figure) is the integration of the pore thickness distribution.

According to the present invention it is demonstrated that that incorporation of the emulsifier polyglycerol ester (PGE) at the air-water interface of air cells achieves a stabilising effect.

It was surprisingly found that an enhanced stabilisation of the air cells was noted when the emulsifier polyglycerol ester (PGE) is present at the air-water interface of air cells in the aerated dessert product.

A presence of the emulsifier polyglycerol ester (PGE) at the air-water interface of air cells in the aerated dessert product reduces a coarsening rate (i.e. kinetics of the coarsening is slowed down significantly) of air cells in the aerated dessert.

The method for the manufacture of the aerated dessert product according to the present invention utilises an effective 2-step foaming process of 1) aerating the PGE solution, and 2) mixing and aerating the aerated PGE solution with an ice-cream pre-mix to produce the aerated ice-cream product. The method ensures that the emulsifier polyglycerol ester (PGE) is present at the air-water interface of air cells in the aerated dessert product.

The emulsifier polyglycerol ester (PGE) was shown to be successful for use in increasing a heat shock stability of the aerated ice-cream product or frozen aerated ice-cream product. The emulsifier polyglycerol ester (PGE) was shown to be successful for reducing the growth of air cells and/or ice crystal growth in the aerated ice-cream product.

The emulsifier polyglycerol ester (PGE) prevents formation of relatively large ice crystals and therefore the physical, sensory and the storage properties as well as the creaminess, softness and smoothness and a resistance to shrinkage are avoided.

### EXAMPLE 3

### Demonstration of the Presence of Emulsifier at the Gas-Water Interface

In this example we analyse the bubble shape relaxation kinetics in melted ice-cream and compare the PGE emulsifier-based ice-cream of the invention with a reference ice-cream.

In particular, it is shown how the shape relaxation of bubbles in a melted ice-cream brings the bubble to a spherical end shape in the case of a non-PGE based system, and to a non-spherical shape in the case of PGE-based ice-cream.

The shape relaxation experiment is conducted as follows. About 0.2 mL of ice cream is taken with a spoon, and deposited on a microscopy glass slide, at room temperature. The ice-cream rapidly melts, and is spread on the glass slide with help of the spoon, so that bubbles appear very visible under a binocular or microscope. Then the spoon is used to create a transient flow by passing it on the glass slides, so that bubbles are deformed under the flow created. The bubble deformation parameter D is defined as the ratio, D=(b−a)/(b+a), where “a” and “b” are defined from the observed bubble shape under the microscope. “b” is the largest value relating two points of the contour of a bubble, and a is the value between the two intersect points of the line orthogonal to the large diameter and passing by its center. During the shape relaxation of a bubble, D is a function of time t:D(t) and decreases from a value at time 0 selected for each bubble after it has reached a non-zero value, to a lower final value.

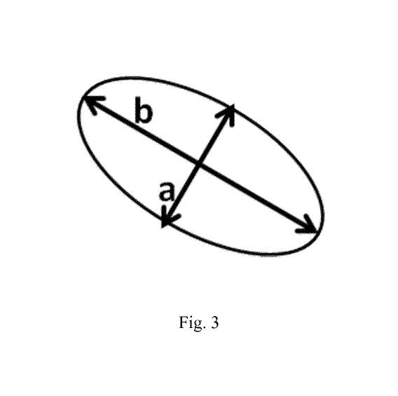

FIG. 3 describes the scheme defining the large diameter “b” and the small diameter “a” for a typical projection of a bubble shape.

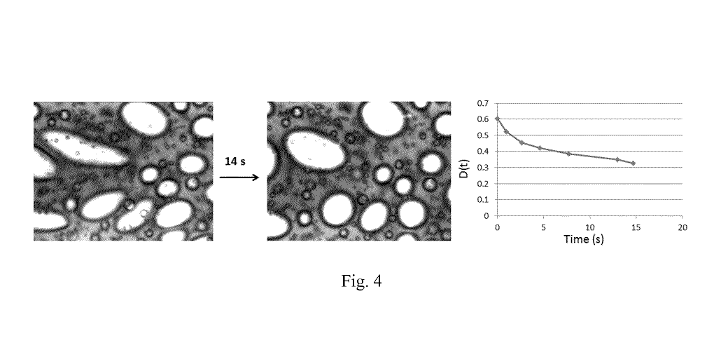

FIG. 4 shows the shape relaxation of bubbles in a melted PGE-based ice-cream. The left image shows deformed shapes of bubbles after passing the spoon nearby to create shear stress. The image on the right shows only partially relaxed shapes after 14 s. It shows clearly the non-sphericity. The curve on the right shows the typical relaxation curve of a bubble after deformation, proving the very long time scales involved in the full relaxation.

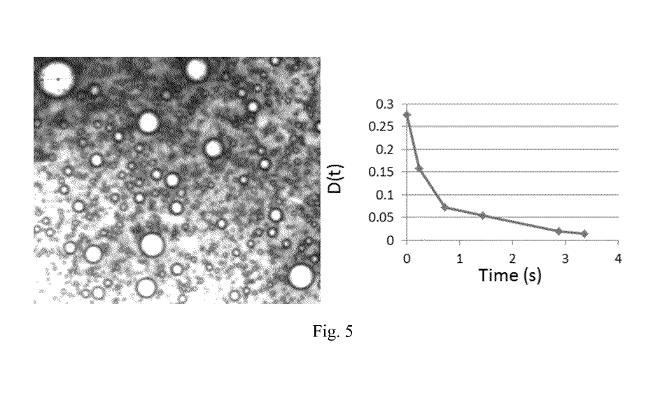

FIG. 5 shows the shape relaxation of bubbles in a melted reference ice-cream (Mövenpick™, Vanilla Dream, purchased in 2014 in the UK). The left image shows fully relaxed bubble shapes after 10 seconds of waiting time following application of shear stress. The curve on the right shows the typical relaxation curve of a bubble after deformation, proving the there are no long time scales involved in the full shape relaxation.

The precise value of stress created is not important here, the only important observation is that, upon repetition of this action, many drops are deformed and their relaxation kinetics recorded.

The main result that is highlighted here is that the values of D for the case of the reference ice-cream (Mövenpick™, see above) go to 0 at long times, i.e. bubbles fully relax their shape. This behavior has been observed on 10 different bubbles. It is the opposite for the PGE-based ice-cream. Bubbles in PGE-based ice-cream initially relax their shape with a kinetics similar to the reference ice-cream, but the shape relaxation almost stops or drastically slows down when the deformation has clearly still non zero value. In other words, very long time scales are involved in the full relaxation of PGE-stabilized bubbles, in contrast to the standard melted ice-cream. This behavior has been observed on 10 different bubbles.

The above observations bring the proof that the presence of PGE at the surface of bubbles prevents them from continuous shape relaxation after an initial faster relaxation regime (associated time scale of the order of seconds). There is a second time scale that is about 2 orders of magnitude slower at least, imparted in our understanding only by the presence of PGE at the bubble surface.

Having thus described the present invention and the advantages thereof, it should be appreciated that the various aspects and embodiments of the present invention as disclosed herein are merely illustrative of specific ways to make and use the invention.

The various aspects and embodiments of the present invention do not limit the scope of the invention when taken into consideration with the appended claims and the forgoing detailed description.

What is desired to be protected by letters patent is set forth in the following claims:

1. An aerated confection, comprising as an emulsifier a polyglycerol ester (PGE), wherein the PGE is present at the gas-water interface of the air bubbles comprised in the aerated confection.

2. The aerated confection to claim 1, wherein the confection comprises between 0.05 to 1.5 wt % PGE.

3. The aerated confection according to claim 1, wherein the PGE is selected from the group consisting of PGE 55, PGE 20 and combinations thereof.

4. The aerated confection according to claim 1, wherein an overrun of the aerated confection is between 5-150%.

5. The aerated confection according to claim 1, which is a frozen or chilled dessert product.

6. A method for manufacturing an aerated confection, comprising the steps of:
(a) mixing water and an emulsifier polyglycerol ester (PGE) to obtain a PGE solution;
(b) aerating the PGE solution; and
(c) mixing the aerated PGE solution with a confection pre-mix to produce the aerated confection.

7. The method according to claim 6, wherein the PGE solution comprises 0.1 to 3.0 wt % PGE.

8. The method according to claim 6, wherein the PGE is selected from the group consisting of PGE 55, PGE 20, and combinations thereof.

9. The method according to claim 6, wherein the aerated PGE solution has an overrun of 20%-400%.

10. The method according to claim 6, wherein in step c) the ratio of the aerated PGE solution to the confection premix in step (c) is between 10:90 and 40:60.

11. The method according to claim 6, wherein step c) is performed at a temperature of between −2° C. to 20° C.

12. The method according to claim 6, wherein step c) is performed at a pressure of between 1-2 bar.

13. The method according to claim 6, wherein step c) is performed to manufacture the aerated confection with an overrun of between 20-150%.

14. The method according to claim 6 comprising freezing the aerated confection.

15. (canceled)

16. A method for increasing a heat shock stability of an aerated confection or frozen aerated confection and/or reducing the growth of air cells and/or ice crystal growth in the aerated confection, comprising as an emulsifier a polyglycerol ester (PGE), wherein the PGE is present at the gas-water interface of the air bubbles comprised in the aerated confection to the confection.
